(19) United States
(12) Patent Application Publication
(10) Pub. No.: US 2009/0112622 A1
(43) Pub. Date: Apr. 30, 2009

(54) METHODS AND PROCESSES FOR A HEALTH CARE SYSTEM

(76) Inventor: CL. ALEX. CHIEN, Haslett, MI (US)

Correspondence Address: Cl. Alex. Chien, HCM-INF LLC., P.O. Box 645, Haslett, MI, 48840, US

(21) Appl. No.: 12/255,711

(22) Filed: Oct. 22, 2008

Related U.S. Application Data
(60) Provisional application No. 61/000,868, filed on Oct. 30, 2007.
(60) Provisional application No. 61/125,721, filed on Apr. 28, 2008.

(51) Int. Cl. G06Q 50/00

(52) U.S. Cl. 705/2

(57) ABSTRACT

Methods and processes for a system of health care that treat patients (10) in a clinic (40) sited on a quasi-sovereign geographic area, including those of indigenous peoples or designated for special development purposes. Patients (10) are transported to the clinic (40) that is staffed by global health care providers (42) and which can be globally-accredited. Clinic (10) can be inter-networked with a hospital, college of medicine, or college of health sciences (60) for quality support. Hospital (60) can be globally-accredited. In one embodiment, patients (10) are transported to Mandan, N. Dak., for treatment by Thai providers (42) at a clinic (40) sited on American Indian nation-lands. Clinic (40) faultlessly inter-networks with a hospital or college of medicine (60) in Bangkok for maximal service quality. Afterwards, patients (10) return home or tour area.

### CROSS REFERENCE TO RELATED APPLICATIONS

This application claims the benefit of provisional applications Ser. No. 61/000,868 filed on Oct. 30, 2007 and acknowledgement mailed Dec. 27, 2007, and Ser. No. 61/125,721 filed on April 30, 2008, both by the present inventor, Cl. Alex. Chien.

### FEDERALLY SPONSORED RESEARCH

Not Applicable

### SEQUENCE LISTING OR PROGRAM

Not Applicable

### REFERENCES CITED

| | | | |
|---|---|---|---|
| 5,377,990 | A | October 1993 | Seeney-Sullivan |
| 5,435,726 | A | December 1993 | Taylor |
| 6,820,057 | B1 | November 2004 | Loch, et al. |
| US 2007/0055620 | A1 | May 2006 | Garcia, et al. |

### OTHER PUBLICATIONS

The New York Times, Section A; Column 0; National Desk; Pg. 1, 2008, Alex Berenson, “Dental Clinics, Meeting a Need With No Dentist.”
Health Affairs, vol 27, no. 5, 1329-1335, 2008, J. Hwang & C. M. Christensen, “Disruptive Innovation In Health Care Delivery: A Framework For Business-Model Innovation.”
Wharton Knowledge, 2008, C. K. Prahalad: “The Poor Deserve World-Class Products and Services.”
Pralahad, C. K. and M. S. Krishnan, “The new age of innovation: driving co-created value through global networks,” 2008, McGraw-Hill.
U. S. National Library of Medicine/National Institutes of Health, 2008, “History of Medicine.”
Deloitte Development, 2008, “Medical Tourism: Emerging Phenomenon in Health Care Industry.”
Annual report, Alaska Native Tribal Health Consortium, 2007.
McKinsey Quarterly, 2007, “Mapping The Market For Medical Travel.”
Alan Greenspan, 2007, “The age of turbulaence,” Penguin Press.
Regina Herzlinger, 2007, “Who killed health care?” McGraw Hill.
M. E. Porter and E. O. Teisberg, 2006, “Redifining health care,” Harvard Business School Press.
M. Harryono and Y.-F. T. Huang, et al., 2006, “Thailand Medical Tourism Cluster,” Harvard Business School.
C. K. Pralahad, 2005, “The fortune at the bottom of the pyramid,” Wharton School Publishing.
Regina Herzlinger, 2004, “Consumer-driven health care,” Jossey-Bass.
A. Potempa, 2004, “Dental group questions Alaska aide program,” Anchorage Daily News.
Indian Health Service and United States and Dept. of Health and Human Services, 2003, “The IHS strategic plan.”
The New York Times, Associated Press, 2003, “Hearing Focuses on Indian Health Care.”
Mother Theresa and L.Vardey, 1995, “A simple path,” Ballantine Books.
Supreme Court of the United States, 480 U.S. 202 (1987). No. 85-1708, “California v. Cabazon Band of Mission Indians.”

### FIELD OF THE INVENTION

The present invention is designed to increase and manage the delivery of quality health care, providing patients with more health care options.

### BACKGROUND OF THE INVENTION—PRIOR ART

In late 2008, the health care system in the United States was described by Prof. Michael Porter of Harvard Business School as “dysfunctional . . . broken,” with “patient needs” frequently “clashing with economic reality” to produce “staggering” amounts of wasted resources. “Health care” was defined generally as medical care, dental care, nursing care, general health care, and allied fields of health care.

The U.S. was not unique in this conundrum, as the health care systems of the world's nations chronically had operational problems. Those problems included financial, funding, level and quality of treatment, and quarrelsome labor relations, including provider strikes.

In the U.S., among the long-standing and systemic issues in health care cited by Porter and others: high costs that often accompany large numbers of very small, dispersed providers; very high level of bureaucracy and organizational conflict; few, if any, patient options on provider choice; uneven quality, including national programs such as Veterans Administration; and uneven distribution, as was the case of over-serviced urban U.S. cities versus under-serviced rural U.S. areas.

In particular, many patients described the situation in U.S. health care as personally difficult. That is, having to deal personally with costly and unhealthy billing disputes with and between providers, payers, and government, including Medicare and Medicaid.

Also in the U.S., federally-recognized Native American Indian tribal-nations had unique concerns. By treaty, the U.S. government agreed to provide tribal members with health care at no cost.

However, American Indian tribal-nations strongly questioned whether that agreement was being honored, given funding and staffing. The tribal nations filed several lawsuits related to this, demanding that the U.S. government fulfill what the tribal nations believe were treaty obligations of the U.S.

As a result of the aforementioned, a small but growing number of residents of the U.S. and other countries began traveling to countries such as India and Thailand for more affordable health care, for treatment in areas such as orthopedic and cardiovascular. This was popularly known as “medical tourism.”

It was widely reported that medical care costs outside the U.S. could cost up to 80% less than in the U.S., though not all “medical tourism” clinics were accredited via global agencies such as Joint Commission International (JCI). In any event, the much-lower cost enabled payment on an upfront cash basis, which could be reimbursed later by U.S. payers such as the Blue Cross/Blue Shield organizations and private insurers.

A significant factor behind the cost differential between the U.S. and popular “medical tourism” countries was that costs outside the U.S. for providers such as medical doctors, doctors of osteopathy, and doctors of dental science were typically lower than in the U S. That was the case, even though many of the overseas providers had been educated and trained in the USA-level United Kingdom and some in the U.S. and USA-affiliated institutions.

In the U.S., a significant barrier to lowering medical care costs were substantial regulatory and legal issues. For instance, some posited that because U.S. provider groups such as specialty medical organizations can strongly influence the supply of new specialty medical providers in the U.S., the provider groups can strongly influence pricing and other critical issues.

Further, because any proposed change to provider-practice environments in the U.S. often required approvals by various organizations such as the American Medical Association (AMA), Medicare, Medicaid, American Hospital Association (AHA), attempts to make changes to contain costs can take more than 10 years to implement.

Also, in the opinion of many, including AMA and AHA, the possibility of questionable medical malpractice lawsuits increased the use of marginally-useful medical testing and treatments, ostensibly to deter lawsuits. Among the outcomes: increased medical care costs, expensive “defensive medicine,” and deterred investment in provider practice innovation.

In response to the obviously distressing situation, inventors attempted to devise a myriad of solutions, mostly in a piecemeal fashion. A search of the USPTO 705/2 class of health care management reveals patents dealing primarily with patient billing and records, not the hands-on, multi-functional aspects of health care delivery.

Public figures also commented on the U.S. health care dilemma. In nebulous generalities, Federal Reserve Board chairman Alan Greenspan wrote about the need for deregulation and global staffing in the professions. Porter offered a theoretical strategy for a total overhaul of U.S. health care—which, given the large number of politically-powerful and moneyed factions involved, could take some time.

In more practically-oriented commentary, Prof. Regina Herzlinger of Harvard Business School championed medical clinics focused on a few procedures, such as hip replacements, to gain cost efficiencies and cost reductions. Somewhat relatedly, Prof. C. K. Prahalad of the University of Michigan Business School explained how India provided advanced medical procedures to some of the world's poorest with focused clinics.

Conversely, Prahalad's research on advanced medicine in India was as opposed to the global charitable work of Mother Teresa and the Missionaries of Charity, which focused on simplicity and cost-effectiveness. J. Hwang, MD/MBA, and Prof. Clayton Christensen, DBA, of Harvard Business School, identified regulatory issues as blocking innovation in U.S. health care delivery—but offered no specific solutions.

On Monday, Apr. 28, 2008, atop its front page, The New York Times focused the world's attention on the emergence of a new health care provider in the Alaskan tribes' Arctic bush-lands—the dental therapist (DT).

For at least four years in Alaska's Arctic regions, the DT practice issue had been quietly simmering under the surface. The DT's role was similar to that of a physician's assistant, but rarely used in the U.S. for reasons unknown.

Near-desperate for basic professional dental services in their remote Arctic homelands for decades, the Alaska Native tribes decided to contract with New Zealand colleges to import DTs and begin DT training programs for Alaska's bitterly-cold bush country. The American Dental Association sued the tribes, saying they were practicing dentistry without a license, but ultimately withdrew their opposition.

Meanwhile, the inventive focus of the Native American Indian community were focused on topics other than health care. This is noted in U.S. Pat. No. 5,377,990 to Seeney-Sullivan, U.S. Pat. No. 5,435,726 to Taylor, and US2007/0055620 to Garcia, et al.

What is needed is a practical, hands-on health care system that functions multi-dimensionally in an affordable, productive fashion for patients, which gives patients another option for health care. Those who read health journals and economic journals know that a very large number of theoretical concepts to address such critical issues have been proposed, most narrowly-focused and on existing health care industry structures.

To actually convert those narrowly-defined theoretical concepts into a practical, useful and multi-functional health care system requires bold, novel, and hands-on experiences, knowledge, and thinking in concurrent multi-functionality. Those include experiences in medical care, health care, advanced business, global engineering and operations, patient advocacy, and the quasi-sovereign rights of indigenous peoples, including Native American Indians.

### SUMMARY OF THE PRESENT INVENTION

Disclosed are methods and processes for a system of health care, medical care, dental care, and allied fields that treat patients in a clinic sited on a quasi-sovereign geographic area.

Those areas include Native American tribal nation-lands and rural, urban, and other special development zones. The clinic can be faultlessly inter-networked with hospitals and colleges of medicine and health care worldwide, to support quality service delivery to patients.

There are additional aspects to the present invention. It should therefore be understood that the preceding is merely a brief summary of some of the embodiments and aspects of the present invention. It should further be understood that numerous changes to the disclosed embodiment can be made without departing from the spirit or scope of the invention. The preceding summary therefore is not meant to limit the scope of the invention. Rather, the scope of the invention is to be determined by appended claims and their equivalents.

### BRIEF DESCRIPTION OF THE DRAWINGS

FIG. 1—System view—a simplified illustration showing the present invention, in an illustrated embodiment; and

FIG. 2—System information and communications technology network—a simplified illustration explaining the present invention's communications network to systematize and increase health care delivery productivity.

### DETAILED DESCRIPTION OF THE INVENTION IN ONE EMBODIMENT

Reference will now be made in detail to the illustrated embodiment of the present invention, an example of which is illustrated in the accompanying drawings, wherein like reference numerals refer to like elements throughout. It is understood that other embodiments may be utilized and structural and operational changes may be made without departing from the scope of the present invention.

The present invention relies on the quasi-sovereign status of indigenous peoples; in the illustrated embodiment, Native American Indians with the United States of America.

American Indian tribal nations assert that, by treaty and the U.S. Supreme Court's Cabazon ruling, they are sovereign and can decide themselves what are appropriate national activities. Those activities include law-making, regulation and taxation, casino gaming, cigarette sales, vehicle registration, judicial systems, international relations, and public services.

The assertion of American Indian sovereignty was affirmed in 1987 by the U.S. Supreme Court in Calif. v. Cabazon, which affirmed the right of the Cabazon tribal-nation to offer high-stakes bingo games. The Cabazon case serves as the legal foundation of the national American Indian gaming industry and other quasi-sovereign American Indian activities.

Given public sensitivity about gaming, if a state government does not offer a particular gaming method, such as slot machines, federal law requires that the American Indian tribal nation and state government negotiate a fair and equitable resolution. For example, in Michigan, tribal nations pay the state a special tax on certain gaming methods, such as slot machines. Further, American Indian tribes openly display their tribal-nation laws and regulations related to gaming.

Thus, based on Cabazon, as well as experience, information, and belief, the present invention in the illustrated embodiment assumes that quasi-sovereignty authority would include tribal authority related to the delivery of health care on tribal property, including medicine and dentistry.

That quasi-sovereign authority would include jurisdiction over allegations of medical malpractice, a significant component of medical care costs in the U.S.

On allegations of medical malpractice, that quasi-sovereign authority can include: mandatory arbitration for allegations of medical malpractice; establishing a reserve fund to appropriately compensate those injured in the rare and inevitable medical error; and setting an appropriate award-cap on debatable “pain and suffering” claims.

As to establishment of the clinic in the illustrated embodiment, the final decision would be up to the American Indian tribal-nation and the medical care providers. A clinic can be built on tribal land, or a mobile medical clinic can be rented from a number of suppliers, including state governments and the U.S. military.

In the illustrated embodiment, it is assumed that a working contractual relationship exists between American Indian tribal-nation and the medical care providers. So, when the providers are to perform medical treatments at the clinic, the tribal-nation's diplomatic relations department works with their counter-parts in the U.S. government to acquire the appropriate travel documents.

Also, as part of their relationship with the tribal-nation, the medical care providers have directed establishment of the clinic's appropriate departments, such as pharmacy, radiology, nursing, and others.

After appropriate referral, patients are transported by optimal method, including ground/air/ground, to a patient clinic that can be accredited by a global authority such as the Joint Commission International (JCI).

The clinic is sited upon a quasi-sovereign geographic area of an indigenous people; in the single illustrated embodiment, the Mandan Indians of Mandan, N. Dak.

At the Mandan clinic, which the Mandan community has decided should be JCI-accredited, medical providers and health providers from outside the U.S. (in the illustrated embodiment, Bangkok, Thailand) are waiting to administer appropriate medical and health treatments, per Herzlinger, Prahalad, and other medical practice and health practice researchers.

After treatment, the providers direct the discharge of patients in an appropriate manner. After discharge, the patients can either go home or stay in the area to tour.

During the patient medical/health procedures, the clinic can be connected in a fault-tolerant manner to a global hospital, or global college of medicine, or global college of health services, in the home countries of the providers of medical, dental, and health services. This is to ensure a maximal level of quality and productivity.

The hospital or college, which can be affiliated with each other, can be accredited globally by groups such as JCI. In the illustrated embodiment, the hospital is accredited.

The fault-tolerant connections, which are redundant and route-diverse, provide video-conferencing, facsimile, data, and voice services between the facilities; in illustrated embodiment, Mandan and Bangkok.

The general use of telecommunications in medical care is known as “telemedicine” and dates back to the first NASA Mercury manned space flights of the late 1950s.

Telemedicine is well-known to those with ordinary skill in the art, such as U.S. Pat. No. 6,820,057 to Loch, et al., which does not involve providers in direct contact with patients.

The use of information and communications technology in health care is known to those with ordinary skill in the art. In the illustrated embodiment, the state of North Dakota has a statewide public fiber-optic network and thus can support advanced telecommunications and health care computing in Mandan.

However, as a major customer in the illustrated embodiment, the Mandan tribal community would have final approval on the choice of information and communications technology systems. That choice can be system-sets somewhere between the most-advanced health care information technology architecture possible at the time and a basic paper-pen-facsimile record-keeping and filing system.

Further, many indigenous peoples live in areas without fiber-optic networking. As such, for the high-speed inter-networking required for advanced health care information technology, such persons are reliant of satellite communication links that are precipitation-sensitive and occasionally problematic.

The practically-useful outcomes of the novel, non-obvious, and multi-dimensional present invention will be more affordable medical care and health care, more patient choices for treatment, more medical services and health services in rural America and for Native American Indians, and more global cooperation on medical care and health care.

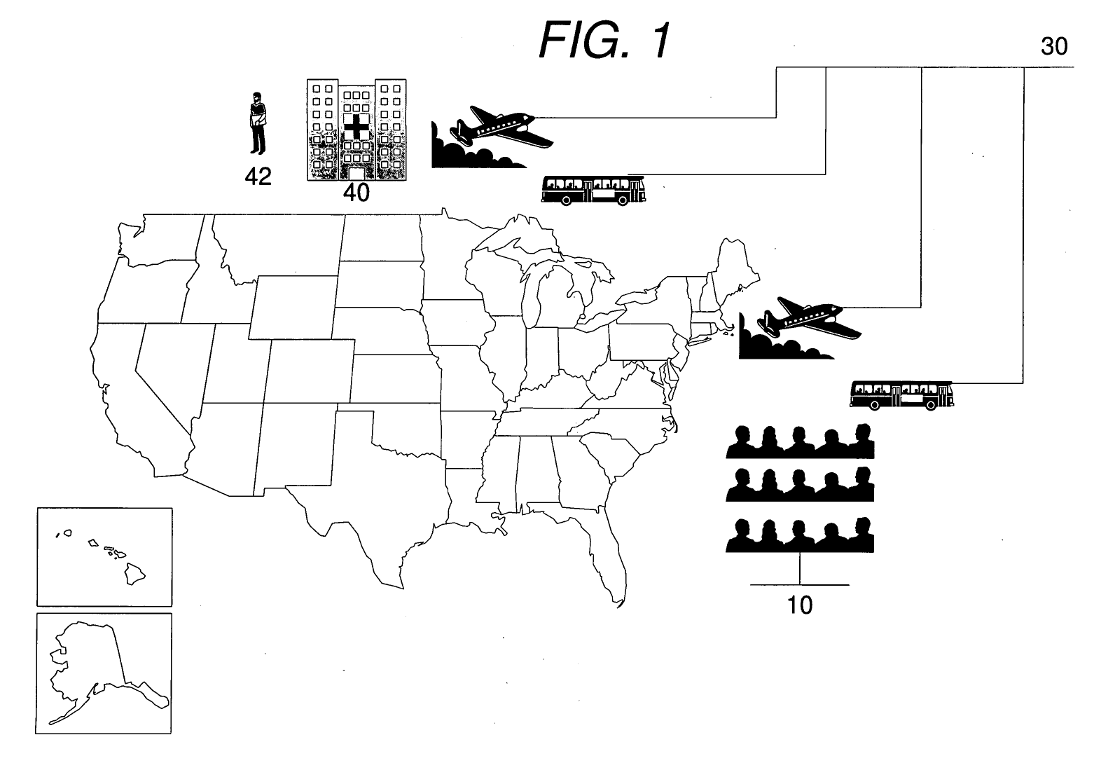

In FIG. 1, patients 10 are transported 30 to medical care and health care clinic 40 where global providers 42 are awaiting to treat them.

In the single illustrated embodiment, clinic 40 is sited on the quasi-sovereign nation-lands of an indigenous people, the Mandan Indians of Mandan, N. Dak.

Mandan was selected due to its proximity to Minot International Airport, Minot, N. Dak., which has a 6,700-foot airstrip, capable of handling a chartered mid-sized jet that transports patients 10 from anywhere in North America.

The illustrated embodiment assumes tribal nation, state, and federal officials have agreed that as most major U.S. hospitals are globally-accredited, clinic 40 should be globally-accredited.

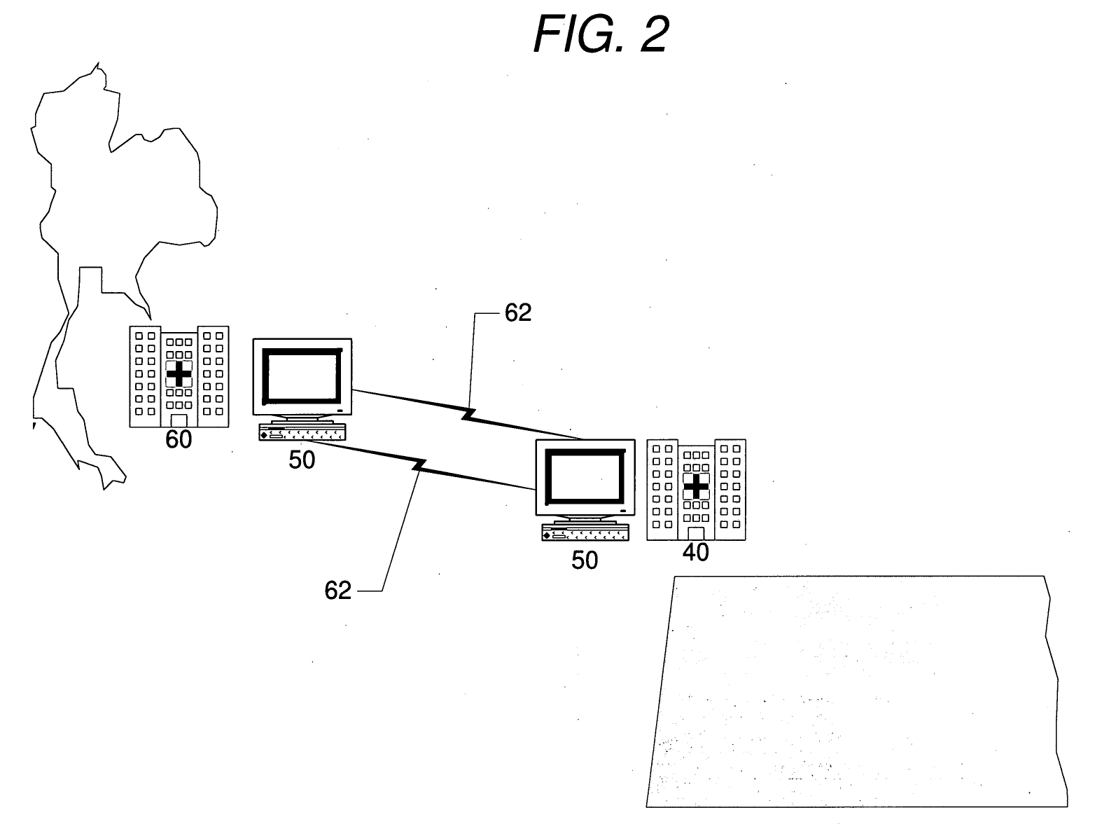

In FIG. 2, during treatments being administered by providers 42, the clinic's communications and information technology unit 50 is faultlessly connected with supporting hospital 60, or college of medicine 60, or college of health care 60 in Bangkok, which has its own communications and information technology unit 50. This has been done to support and enhance service quality.

In this embodiment, hospital 60 in Bangkok is globally-accredited, and has inter-networking links to other hospitals in the world, for consultations and other matters.

The communications technology units 50 at clinic 40 and hospital 60 are connected by fault-tolerant communications links 62. The links 62 are redundant and route-diverse.

At least ninety days previous to treatments starting and based on the number of patients 10 involved, clinic 40 schedules an appropriate number of treatment days and provider time to treat the patients 10 involved. Depending on the treatment demand involved, the number of treatment days can be a week, a month, or an entire spring, summer, or fall season.

Clinic 40 then contracts with hospital 60 to supply services of global providers 42 for the number of treatment days required by patients.

At least 15 days prior to treatment being started, clinic 40 is provisioned with an appropriate number of supplies and auxiliary staff.

After treatment and appropriate discharge, patients 10 can return home or tour the area.

What is claimed is:

1. Method for a health care and medical care system to deliver and support quality-assured medical care and health care to patients in a specially-designated patient clinic staffed by global health providers, faultlessly inter-networked with a global hospital, or global college of medicine, or global college of health services, compromising of the steps of:

2. the method of claim 1, comprising of the transporting patients to a patient clinic that can be accredited by global health care accrediting organizations such as the Joint Commission International (JCI);

3. the method of claim 1, comprising of the clinic being sited on quasi-sovereign nation-lands of indigenous people, including Native American Indians, or special development zones, including urban or rural, a first means for providing patients with another health care option;

4. the method of claim 1, comprising of clinic staffing by medical, dental, and health providers from countries worldwide, such as Thailand, India and Hungary, many of whom were educated and trained in United Kingdom-affiliated facilities and some in USA-affiliated facilities, a second means for providing patients with another health care option;

5. the method of claim 1, comprising of faultlessly inter-networking the clinic with a global hospital, or global college of medicine, or global college of health services, that can be globally-accredited and using video-voice-data communication devices that can operate 24 hours a day, seven days a week, to support maximal health care service quality; and

6. the method in claim 1, comprising of inter-networked health care information and communications technology systems at the clinic and hospital that can range technologically between paper-pen-facsimile to the most-advanced computing system available at the time, a third means for providing patients with another health care option.

7. Process for a medical care and health care system to deliver and support quality health care, including medicine, from a patient clinic staffed by global health professionals, compromising of the steps of:

8. the method of claim 2, comprising of transporting patients to the clinic;

9. the method of claim 2, comprising of the clinic being positioned in special development zones, including urban or rural, or quasi-sovereign nation-lands of indigenous people, including Native American Indians, a first means to providing patients with another health care option;

10. the method of claim 2, comprising of resourcing the clinic with global health providers from medicine, dentistry, health care, professional nursing, or allied fields, a second means for providing patients with another health care option; and

11. the method in claim 2, comprising of information and communications technology systems that can range technologically between the most-advanced systems available at the time to paper-pen-facsimile, a third means for providing patients with another health care option.

12. Method and process for a medical care and health care system to deliver and support quality medical care and health care, from a patient clinic staffed by global health care providers and that can be inter-networked with a global hospital, or global college of medicine, or global college of health services, compromising of the steps of:

13. the method and process of claim 3, comprising of transporting patients to the clinic;

14. the method and process of claim 3, comprising of the clinic being sited on quasi-sovereign nation-lands of indigenous people, including Native American Indians, or special development zones, including rural or urban, a first means to providing patients with another health care option.

15. the method and process of claim 3, comprising of clinic staffing by global medical, dental, and health providers from countries such as Thailand, India and Hungary, a second means to providing patients with another health care option;

16. the method of claim 1, comprising of inter-networking the clinic with a global hospital, or global college of medicine, or global college of health services, that can be globally-accredited and using video-voice-data communication devices to support health care service quality; and

17. the method and process of claim 3, comprising of information and communication linkages between clinic and hospital, as basic as telephonic and facsimile service and as advanced as the highest-speed inter-networking possible at the time, to support the delivery of health care.
